(19) United States
(12) Patent Application Publication
(10) Pub. No.: US 2023/0415703 A1
(43) Pub. Date: Dec. 28, 2023

(54) VEHICLE WIPER ASSEMBLY AND WIPER SECURING METHOD

(71) Applicant: Ford Global Technologies, LLC, Dearborn, MI (US)

(72) Inventors: Jose Garcia Crespo, Bloomfield Twp., MI (US); Jose Luis Rosas Juarez, Mexico City (MX)

(21) Appl. No.: 17/850,288

(22) Filed: Jun. 27, 2022

(51) Int. Cl. B60S 1/40; B60S 1/34; B60S 1/38

(52) U.S. Cl. CPC B60S 1/4038; B60S 1/3465; B60S 1/3856; B60S 2001/4061

(57) ABSTRACT

A wiper assembly includes a bent arm providing a channel. The bent arm is configured to connect to a shaft of an actuator. The wiper assembly additionally includes a wiper blade slidably received within the channel. A method includes securing a bent arm to a shaft of an actuator, and biasing a wiper blade against a window during the securing.

### TECHNICAL FIELD

This disclosure relates generally to a window wiper and, more particularly, to a window wiper having a bend.

### BACKGROUND

Vehicles can include wipers that move back and forth to remove rain, snow, ice, and other debris from the windows of the vehicle. Wipers can include several components. Wipers can include an arm that connects a separate blade carrying structure to an actuator. A coil spring biases the blade carrying structure toward the window.

### SUMMARY

In some aspects, the techniques described herein relate to a wiper assembly, including: a bent arm providing a channel, the bent arm configured to connect to a shaft of an actuator; and a wiper blade slidably received within the channel.

In some aspects, the techniques described herein relate to a wiper assembly, further including a spline embedded within the wiper blade.

In some aspects, the techniques described herein relate to a wiper assembly, wherein the spline is a first material and the wiper blade is a different, second material.

In some aspects, the techniques described herein relate to a wiper assembly, wherein the spline is a metal or metal alloy material, wherein the wiper blade is a polymer-based material.

In some aspects, the techniques described herein relate to a wiper assembly, wherein the wiper blade is overmolded about the spline.

In some aspects, the techniques described herein relate to a wiper assembly, wherein the spline has a rectangular cross-section.

In some aspects, the techniques described herein relate to a wiper assembly, wherein the bent arm is configured to directly connect to the actuator shaft.

In some aspects, the techniques described herein relate to a wiper assembly, wherein the wiper blade is part of a rear window wiper assembly.

In some aspects, the techniques described herein relate to a wiper assembly, further including an endcap secured to a first end of the bent arm, and a fastener cover secured to an opposite, second end of the bent arm.

In some aspects, the techniques described herein relate to a wiper assembly, wherein the endcap and the fastener cover are a polymer-based material.

In some aspects, the techniques described herein relate to a wiper assembly, wherein the bent arm is configured to be biased against a vehicle window.

In some aspects, the techniques described herein relate to a wiper assembly, wherein the vehicle window is a vehicle rear window.

In some aspects, the techniques described herein relate to a wiper assembly, wherein the bent arm is configured to be biased against the vehicle window due to a bend in the bent arm.

In some aspects, the techniques described herein relate to a wiper assembly, wherein the bent arm is configured to be biased against the vehicle window without a coil spring.

In some aspects, the techniques described herein relate to a wiper assembly, wherein the bent arm includes an aperture that receives the shaft.

In some aspects, the techniques described herein relate to a wiper assembly, further including a mechanical fastener that secures the bent arm to the shaft.

In some aspects, the techniques described herein relate to a wiper assembly, wherein the mechanical fastener is a nut.

In some aspects, the techniques described herein relate to a method, including: securing a bent arm to a shaft of an actuator; and biasing a wiper blade against a window during the securing.

In some aspects, the techniques described herein relate to a method, wherein the window is a rear window.

In some aspects, the techniques described herein relate to a method, wherein the shaft is received within an aperture of the bent arm during the securing.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a rear view of a vehicle having a wiper assembly.

FIG. 2 illustrates a top perspective view of the area of the vehicle having the wiper assembly.

FIG. 3 illustrates a section view taken at line 3-3 in FIG. 2.

FIG. 4 illustrates a top view of the wiper assembly moving toward an installed position.

FIG. 5 illustrates the top view of FIG. 4 when the wiper assembly is closer to the installed position.

FIG. 6 illustrates the top view of FIG. 4 when the wiper assembly is in the installed position.

### DETAILED DESCRIPTION

This disclosure details vehicle wiper systems. In exemplary embodiments, a wiper assembly of a wiper system includes a blade carrying structure that is bent and connected to an actuator shaft. This approach can load the blade against a window without the need for a separate coil spring. These and other features of this disclosure are described in greater detail below.

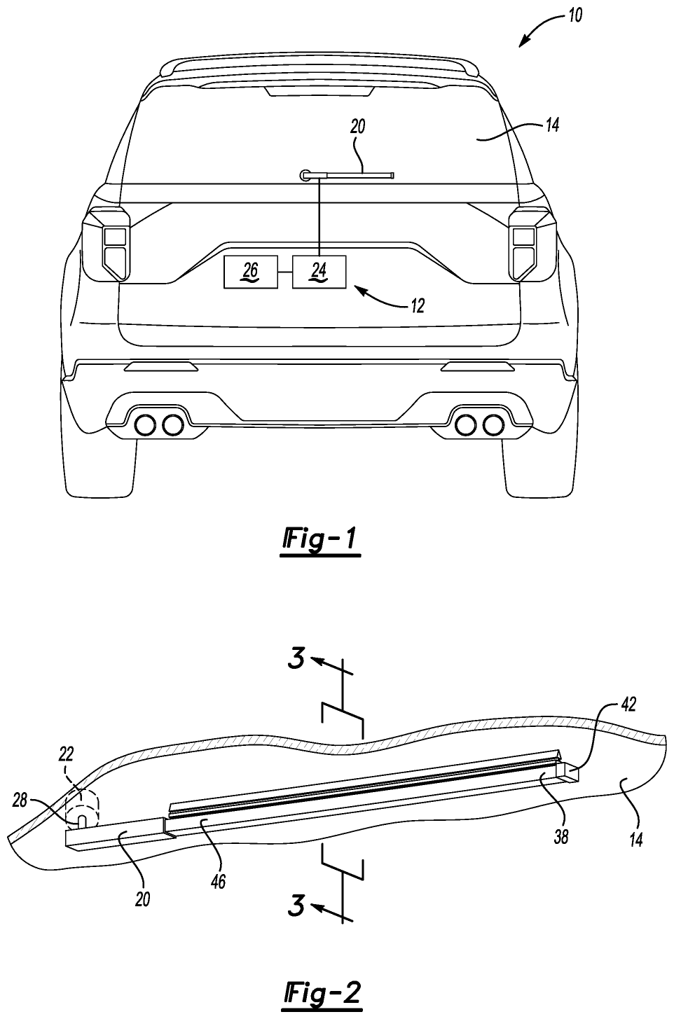

FIG. 1 schematically illustrates a vehicle 10. The vehicle 10 could be a car, a truck, a van, a sport utility vehicle, or any other type of vehicle. The vehicle 10 could also be a conventional, internal combustion engine powered vehicle, a traction battery powered hybrid electric vehicle (HEV), a plug-in hybrid electric vehicle (PHEV), etc.

Although a specific component relationship is illustrated in the figures of this disclosure, the illustrations are not intended to limit this disclosure. The placement and orientation of the various components of the vehicle 10 are shown schematically and could vary within the scope of this disclosure. In addition, the various figures accompanying this disclosure are not necessarily drawn to scale, and some features may be exaggerated or minimized to emphasize certain details of a particular component.

The vehicle 10 includes a wiper system 12. The wiper system 12 is capable of wiping away precipitation (e.g., rain, snow, ice, and/or other debris) that accumulate on the rear window 14 of the vehicle 10. The wiper system 12 could be used with another window of the vehicle 10 in another example, such as a front windshield of the vehicle 10.

The example wiper system 12 includes a wiper assembly 20, an actuator 22 (e.g., motor), a control module 24, and a power supply 26. While the example wiper system 12 includes a single wiper assembly 20, in other examples, the wiper system 12 may include more than one wiper assembly 20 that can be within a tandem, opposed dual, or any other type of wiper system.

The wiper assembly 20 and actuator 22 are electrically coupled to the control module 24, which in turn may be electrically coupled to the power supply 26. Although schematically illustrated as a single controller, the control module 18 may be part of a vehicle control system that includes a plurality of additional control modules for interfacing with and commanding operation of the various components of the vehicle 10. In an embodiment, the control module 18 is part of a body control module (BCM) of the vehicle 10.

The power supply 26 may be a dedicated battery of the wiper system 12, a low voltage battery (e.g., a 12V battery) of the vehicle 10, a high voltage traction battery of the vehicle 10, etc. While the control module 24 and the power supply 26 are shown separately, these components could be integrated into a combined unit in some embodiments.

With reference to FIG. 2 and continued reference to FIG. 1, to move the wiper assembly 20 over the rear window 14, the wiper assembly 20 is coupled to a shaft 28 of the actuator 22. The shaft 28 rotates in response to commands from the control module 24 to move the wiper assembly 20 back-and-forth to drive the wiper assembly 20 across the rear window 14.

The wiper system 12 shown in FIG. 1 and described in the preceding paragraphs is but one example of how wipers could be configured and arranged for wiping from the rear window 14. A person of ordinary skill in the art would understand that other wiper configurations and arrangements are possible. Accordingly, it should be appreciated that the specific wiper arrangement of FIG. 1 is not intended to limit this disclosure.

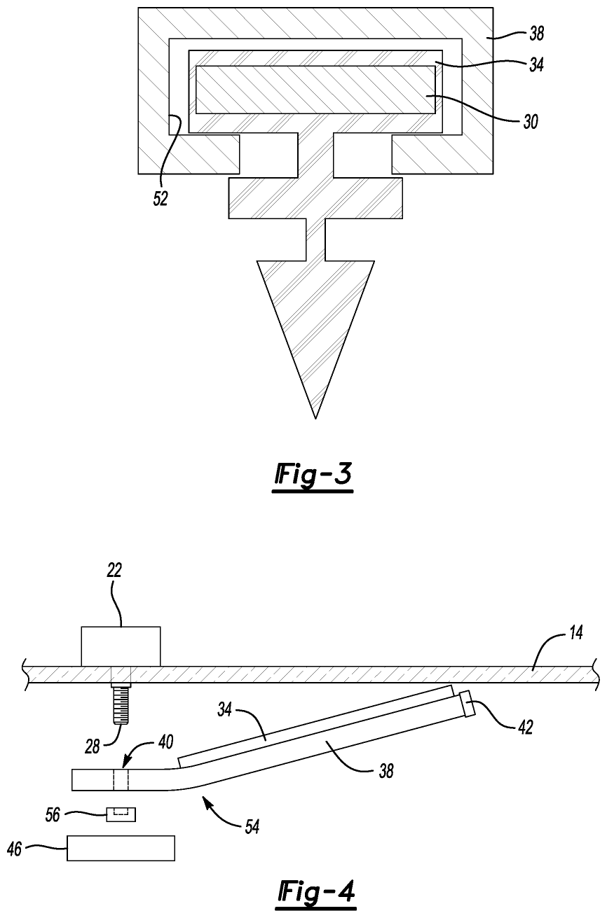

With reference now to FIGS. 2 to 6, the wiper assembly 20, in this example, includes five primary components: a spline 30, a wiper blade 34, a bent arm 38, an endcap 42, and a fastener cover 46. To the extent the wiper system 12 includes more than one wiper assembly 20, the additional wipers may be arranged in substantially the same way as the wiper assembly 20 of FIGS. 2-6.

The spline 30 is a metal or metal alloy in this example. The spline 30 helps to, in particular, reinforce the wiper blade 34. The spline 30 has a rectangular cross-section in this example. The example spline 30 is embedded within the wiper blade 34.

The wiper blade 34, in this example, is a polymer-based material, such as rubber. In an embodiment, the wiper blade 34 is made of a relatively stiff silicone rubber, such as ethylene propylene diene monomer (EPDM) rubber, natural rubber, or synthetic rubber. The material of the wiper blade 34 may have a Shore A hardness above about 60, in one embodiment, or within a range of about 80 to about 90, in other embodiments. In this disclosure, the term “about” means that the expressed quantities or ranges need not be exact but may be approximated and/or larger or smaller, reflecting acceptable tolerances, conversion factors, measurement error, etc.

The wiper blade 34 can be overmolded about the spline 30. In another example, the wiper blade 34 is molded, and the spline 30 then inserted into the wiper blade 34. In yet another example, the wiper blade 34 could be extruded about the spline 30. After extruding, the spline 30 and wiper blade 34 combination could be then cut to a desired length. In the examples where the wiper blade 34 is overmolded, the end cap 42 at a tip of the wiper blade 34 could also be overmolded rather than a separate piece that needs to be assembled to the wiper blade 34.

The bent arm 38 can be metal or metal alloy. In another example, materials other than metal and metal alloys could be used to form the bent arm 38. One end of the bent arm 38 includes an aperture 40 that receives the shaft 28 to connect the wiper assembly 20 to the actuator 22. The aperture 40 can be a keyhole in some examples, which includes a flattened area to correctly orient the wiper assembly 20 relative to the shaft 28.

The bent arm 38 includes a channel 52 that slidably receives the spline 30 and the wiper blade 34. The endcap 42 can be snap-fit to the bent arm 38 to help hold the spline 30 and the wiper blade 34 within the channel 52. The endcap 42, in another example, is pivotably connected to the bent arm 38 via a living hinge.

The bent arm 38 is formed to have bend 54 (see FIG. 4). The spline 30 and the wiper blade 34 conform to the bend 54 when the spline 30 and the wiper blade 34 are slidably received within the channel 52. The bend 54 can cause the bent arm to have an arced or curved shape.

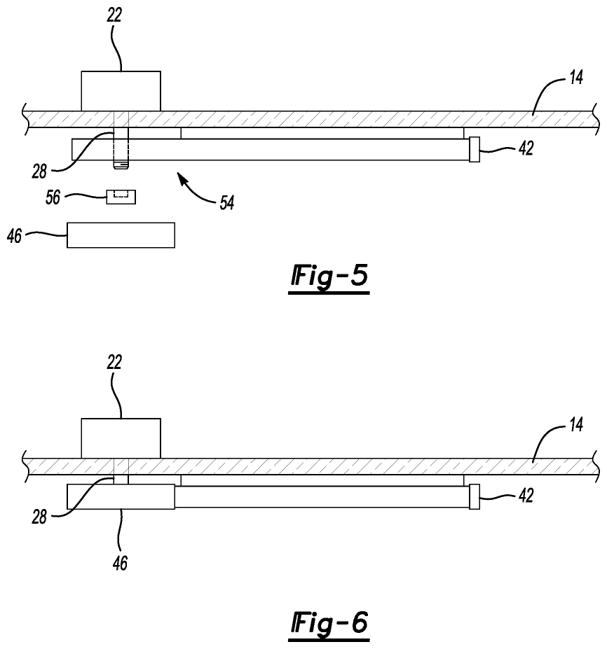

The bend 54 is sufficient enough to bias or cantilever the wiper assembly 20 against the rear window 14 when the wiper assembly 20 is secured in the installed position. That is, as wiper assembly 20 is moved from the uninstalled position of FIG. 4, to the partially installed position of FIG. 5, and to the installed position of FIG. 6, the wiper assembly 20 contacts the rear window 14 and flexes from a more bent position shown in FIG. 4 to a less bent position shown in FIG. 6.

In this example, a mechanical fastener 56—here a nut—is used to directly connect the wiper assembly 20 the shaft 28. The fastener cover 46 is then snap-fit to the bent arm 38 to cover the mechanical fastener 56. The endcap 42 is secured to a first end of the bent arm 38. The fastener cover 46 is secured to an opposite, second end of the bent arm 38. The fastener cover 46 and endcap 42 can be a polymer-based material.

The control module 18 can control the flow of power from the power supply 26 to the actuator 22 to control rotation of the shaft 28. The control module 18 can include a processing unit and non-transitory memory for executing the various control strategies of the wiper system 12. The processing unit of the control module 18, in an embodiment, is configured to execute one or more programs stored in the memory of the control module 18. The control module 18 can receive and process various inputs to control rotation of the shaft 28 and thus movement of the wiper 16. Starting and stopping of the wiper 16 can be controlled along with a speed of the of the wiper 16, for example.

The vehicle wiper utilized a bent or cantilevered support structure to hold the wiper blade 34 and to secure the wiper assembly 20 to the shaft 28 of the actuator 22. No coil spring is required to bias the wiper blade against a window. The wiper blade is biased against a window due to the bend 54 in the bent arm 38. Further, no separate connector arm and blade carrying member are required. The biasing force on the wiper assembly 20 can be distributed rather evenly by adjusting an amount of the bend 54. Such an evenly distributed load can facilitate cleaning the window.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

1. A wiper assembly, comprising:
a bent arm providing a channel, the bent arm configured to connect to a shaft of an actuator the bent arm is configured to be biased against a vehicle window due to a bend in the bent arm; and
a wiper blade slidably received within the channel, wherein the wiper blade conforms to the bend in the bent arm.

2. The wiper assembly of claim 1, further comprising a spline embedded within the wiper blade.

3. The wiper assembly of claim 2, wherein the spline is a first material and the wiper blade is a different, second material.

4. The wiper assembly of claim 3, wherein the spline is a metal or metal alloy material, wherein the wiper blade is a polymer-based material.

5. The wiper assembly of claim 3, wherein the wiper blade is overmolded about the spline.

6. The wiper assembly of claim 2, wherein the spline has a rectangular cross-section.

7. The wiper assembly of claim 1, wherein the bent arm is configured to directly connect to the shaft of the actuator.

8. The wiper assembly of claim 1, wherein the wiper blade is part of a rear window wiper assembly.

9. The wiper assembly of claim 1, further comprising an endcap secured to a first end of the bent arm, and a fastener cover secured to an opposite, second end of the bent arm.

10. The wiper assembly of claim 9, wherein the endcap and the fastener cover are a polymer-based material.

11. (canceled)

12. The wiper assembly of claim 1, wherein the vehicle window is a vehicle rear window.

13. (canceled)

14. The wiper assembly of claim 1, wherein the bent arm is configured to be biased against the vehicle window without a coil spring.

15. The wiper assembly of claim 1, wherein the bent arm includes an aperture that receives the shaft.

16. The wiper assembly of claim 15, further comprising a mechanical fastener that secures the bent arm to the shaft.

17. The wiper assembly of claim 16, wherein the mechanical fastener is a nut.

18.-20. (canceled)

21. The wiper assembly of claim 1, wherein the bent arm includes no more than one bend.

22. The wiper assembly of claim 1, wherein the bent arm is entirely uncorrugated.

23. The wiper assembly of claim 9, wherein the endcap is overmolded to the bent arm.
